(19) United States
(12) Patent Application Publication
(10) Pub. No.: US 2015/0342215 A1
(43) Pub. Date: Dec. 3, 2015

(54) DUAL TEXTURED CONFECTIONERY PRODUCT AND METHOD OF MAKING A DUAL TEXTURED CONFECTIONERY PRODUCT

(71) Applicant: THE HERSHEY COMPANY, Hershey, PA (US)

(72) Inventor: Julia J. WATTERSON, Hummelstown, PA (US)

(21) Appl. No.: 14/654,666

(22) PCT Filed: Oct. 15, 2014
(86) PCT No.: PCT/US2014/060619

§ 371 Date: Jun. 22, 2015

Related U.S. Application Data
(60) Provisional application No. 61/892,738, filed on Oct. 18, 2013.

(51) Int. Cl. A23G 3/40; A23G 3/54; A23G 3/42

(52) U.S. Cl. CPC A23G 3/40; A23G 3/42; A23G 3/54; A23V 2002/00

(57) ABSTRACT

A method of forming a crème filled snack is disclosed in which a fat-based crème is provided as a center portion, then a carbohydrate based syrup and a powdery starch blend are repeatedly alternately and separately applied over the center portion to form a coating around the center portion. The coated center portion is then cooked such that the applied coating forms a crisp outer shell resulting in a dual-textured confectionery product.

### CROSS REFERENCE TO RELATED APPLICATIONS

This application claims the benefit of and priority to U.S. App. No. 61/892,738 filed Oct. 18, 2013 and which is hereby incorporate by reference in its entirety.

### FIELD

This application is directed to a confectionery product and a method of making confectionery products. More particularly, the present invention is directed to dual textured confectionery snacks.

### BACKGROUND

It is often desirable to provide a comestible product having a crunchy outer shell. Producing such products that also have a soft filling presents a host of difficulties, particularly when dealing with baked snacks and especially with bite-sized baked snacks. These difficulties are further exasperated when the soft filling is a fat-based filling, such as a fat-based crème.

One difficulty involved with the production of baked snacks having fat-based crème fillings is the ability of the fat-based crèmes to melt and/or flow when exposed to temperatures above the melting point of the base fat. The melted crème can leak through the dough encasement during baking, causing product defects such as visible leakage.

One way to avoid this leakage is to limit the fill percentage of the baked snack to less than 50% by weight. Conventional bite-size baked snack pieces have between 35 to 50 percent crème. However, these products may be less desirable to consumers because of the low amount of crème.

Another potential way of avoiding leaker defects is to decrease the flowability of the soft center through the use of viscosity modifiers, although the use of such additives in conventionally effective amounts also causes negative textural properties, including dryness and crumbliness. These characteristics are exacerbated if used in baked products where the treated item is exposed to high temperatures during baking.

These and other drawbacks are associated with current methods used for forming crème filled snacks.

### SUMMARY

Exemplary embodiments are directed to a crème filled snack and methods of making a crème filled snack having increased amounts of crème filling.

According to an exemplary embodiment, a method of making a crème filled snack includes providing a fat-based crème as a center portion, applying a carbohydrate based syrup over a surface of the center portion, applying a powdery starch blend over the syrup, and repeating the steps of applying the carbohydrate based syrup and powdery starch blend to form a shell around the center portion. The shell and the center portion form a coated comestible which is cooked to form the crème filled snack having a crisp outer shell.

According to another exemplary embodiment, a crème filled snack includes a fat-based crème center and a shell around the fat-based crème center, the shell comprising at least three pairs of alternating carbohydrate based syrup and powdery starch blend layers. The shell is configured to crisp during cooking to form a crunchy shell.

Among the advantages of exemplary embodiments is that methods described herein produce a crème filled snack having a crispy shell that includes at least 55% crème filling by weight. Despite the ability to achieve a high percentage of crème filling, exemplary embodiments exhibit little to no leakage.

Another advantage is that the methods produce a crème filling having a reduced amount of viscosity-increasing ingredients, which reduces formation of dryness and/or crumbliness formed in the crème during baking.

Still another advantage is that the methods provide control over the thickness of the applied shell, which in turn provides control over the weight percentage of the crème.

A further advantage is that the methods produce a crème filled snack having various flavor combinations. Natural and/or artificial flavors may be introduced into the center and/or coating without compromising the integrity of the crème filled snack. Additionally, inclusions such as nut pieces or cookie bits may be added to the crème filling to provide additional texture and/or flavor experiences in the crème filled snack.

Yet a further advantage is that the methods can be used to produce a crème filled snack across a range of final product sizes with little or no changes to processing equipment.

Other features and advantages of the present invention will be apparent from the following more detailed description of exemplary embodiments that illustrate, by way of example, the principles of the invention.

### DETAILED DESCRIPTION OF EXEMPLARY EMBODIMENTS

Exemplary embodiments are directed to fat-based crème filled snacks having a crunchy outer shell and methods of making such snacks to yield confectioneries having a dual-texture. Such snacks have a high percentage of crème filling and achieve a satisfying mouthfeel while also being visually appealing.

Accordingly, embodiments of the present disclosure, in comparison to methods and snacks not using one or more of the features disclosed herein, provide increased weight percentage of crème in the snack, decrease leakage of crèmes from the snack, decrease dryness of crèmes in the snack, decrease crumbliness of crèmes in the snack, or a combination thereof.

In one embodiment, a method of making a crème filled snack includes preparing a fat-base crème, shaping the crème to form a center portion having an easily panned shape, applying a carbohydrate based syrup over the center portion, applying a powdery blend containing a starch over the syrup layer, and separately repeating those application steps to a desired thickness of a shell coating. After the desired thickness of the shell coating is reached, the coated center is cooked to crisp the shell and form the crème filled snack.

The crème includes any suitable soft crème for forming the center portion of the crème filled snack, particularly including fat-based crèmes. By fat-based crème it is meant that the crème contains at least 18% by weight of a fat, which is typically, but not necessarily, a solid fat. For example, in one embodiment, the fat includes any suitable combination of vegetable or animal fats, such as, but not limited to, cocoa butter, cocoa butter equivalents, or a combination thereof. Cocoa butter equivalents may include shea nut oil, palm oil, and Illipe oil. Other fats may include palm kernel oil, coconut oil, soybean oil, dairy butter, or a combination thereof. Suitable fat-based crèmes include, but are not limited to, a cocoa-butter based crème, chocolate crème (of both standard of identity or non-standard), white chocolate crème, vanilla crème, nut butter crème (e.g. peanut butter, hazelnut butter, etc.), and fruit flavored crème. It will be appreciated that in some embodiments, the fat-based crème may be tempered.

In one embodiment, the crème is optionally infused with up to 2% by weight of a humectant or other viscosity modifier to increase the viscosity of the crème. In some embodiments, the viscosity modifier is present in the range of 0.5% to 2% by weight of the crème. The use of a limited amount of a viscosity modifier decreases flowability of the crème, which can aid in the ability of the crème to maintain a desired shape. However, the levels employed are low enough to avoid imparting a dry, crumbly texture often associated with the use of such ingredients in other fat-based products.

One suitable class of viscosity modifiers includes humectants, such as polyols, although other classes of viscosity modifiers may also be employed. Among polyols, glycerol is preferred, although sorbitol and other compounds are also suitable. Another viscosity modifier includes water, added directly, through the use of a water containing compound (e.g., corn syrup, dextrose monohydrate), or a combination thereof.

The fat-based crème is then shaped to form a center portion. While any shape is possible, the shapes are typically selected to be compatible with a panning process as subsequently described. Typically, the crème may be formed into spherical, spheroid, or ovoid shapes. Suitable shaping methods include, but are not limited to, drop rolling, moulding, extruding, depositing, or a combination thereof Exemplary embodiments are particularly useful for forming bite-sized snacks and the crème centers are typically formed having a radius (or widest dimension in the case of non-spherical shapes) in the range of about 10 mm to about 25 mm. However, the radius may be less than 10 mm or greater than 25 mm based upon desired characteristics of the crème filled snack.

After shaping, an aqueous carbohydrate based syrup is applied over a surface of the center portion to form a syrup layer. In one embodiment, the syrup is an aqueous sucrose solution. Other ingredients such as salt, fructose, glucose, maltose, lactose, glucose syrup, corn syrup, corn syrup solids, or other additives may also be included in the syrup.

The carbohydrate based syrup includes between about 30% and about 70% by weight solids and in some embodiments is about 60% by weight solids. The solids portion includes any suitable soluble carbohydrates, such as, but not limited to, sucrose, glucose, maltose, lactose, fructose, corn syrup, corn syrup solids, rice syrup, agave syrup, or a combination thereof. In some embodiments, soluble fibers, such as polydextrose, inulin, or other suitable soluble fibers, are partially or entirely employed as the soluble carbohydrate content in the syrup.

The syrup is usually cooked, typically up to around 100° C. (212° F.), which can be useful to better dissolve the carbohydrate solids in forming the syrup. After any cooking, the syrup is cooled to between about 21.1° C. (70° F.) and about 23.9° C. (75° F.). The cooled syrup is then applied over the centers, typically by pan coating using a conventional pan coater although other coating methods, such as belt coating, are also contemplated. The aqueous carbohydrate based syrup provides a moisture source for the reduced flow crème during the cooking step. The moisture in the syrup evaporates during cooking, which helps cool the surface of the center crème and also reduces or eliminates the formation of a dry and/or crumbly texture within the crème center.

A powdery starch blend is then applied over the syrup layer, which is advantageously accomplished again typically using a conventional pan coater. The powdery starch blend includes starch combined with a flour. It will be appreciated that while flours may naturally contain starch, separate reference to the term starch is readily understood within the art to refer to a different ingredient than flour, the starch existing independently in powder form and generally composed of more than 90% glucose polymers, usually in the form of amylose and amylopectin, and typically having a protein content of less than 1%.

The starch may be any edible native or modified starch or combinations of those starches. Exemplary starches include corn starch, as well as potato starch, tapioca starch, arrowroot, rice starch and wheat starch. In some embodiments, the starch is pre-gelatinized waxy corn starch. The starch is typically present as about 25% to about 60% by weight of the powdery starch blend.

The powdery blend also includes between about 40% and about 60% of one or more flours. Suitable flours for use in the blend include, but are not limited to, wheat, rice, potato, almond, and cocoa powder, as well as any combination thereof. In some embodiments, up to 10% by weight of a fat is also incorporated into the powdery blend, to provide a change in texture and/or control expansion of the shell during cooking. In some cases, the fat may be a liquid oil such as, but not limited to, canola oil, soybean oil, corn oil, olive oil, or safflower oil. The powdery starch blend remains powdery with the addition of up to about 10% liquid oil. Other additives such as sugar, salt, or other flavoring ingredients may also be part of the powdery blend.

The application of the aqueous carbohydrate syrup and powdery starch blend are repeated sequentially to form the outer coating until the desired weight percentage is achieved when the shell coating is formed. The shell typically ranges from 25% to 45% by weight, typically 30 to 35% by weight of the pre-baking weight of the total piece weight, which yields a snack in which the crème center is at least 55% by weight, with the total weight loss during cooking (primarily water content) being small (i.e., typically less than about 7% by weight).

The amount of syrup and powdery starch blend applied in each layer to achieve the overall result may be varied and will depend upon the surface area of the center portion and/or prior coating layers to which the layer is being applied. It will be appreciated that the syrup is applied to completely coat the center portion and/or coated comestible without excess, and the powdery starch blend is applied to absorb the syrup without excess. For example, in one embodiment, the syrup and the powdery starch blend are each applied at about 4.5% to about 6% by weight of the center portion, for about six to seven iterations, to form the coating at about 30% to 35% of the total coated comestible weight. In another embodiment, the syrup and the powdery starch blend are each applied at about 1.0% to about 1.5% by weight of the center portion, for about twenty to twenty-two iterations, to form the coating at about 30% to 35% of the total coated comestible weight. The particular amount or time will vary based on numerous factors and manufacturing conditions. Applying excess syrup and/or not enough powdery starch blend will cause the coated comestibles to stick together, whereas excess powdery starch blend will not adhere and will be wasted.

In some embodiments, after the appropriate number of alternating syrup and powdery blend layers have been applied, the coated comestibles are then sprayed with a rewetting or finishing liquid to uniformly rewet the surface of the coated comestibles prior to baking. In other embodiments, the coated comestibles are crisped in a snack crisper without rewetting the surface with the rewetting or finishing syrup. Rewetting the surface of the coated comestible prior to baking facilitates an even coating expansion during baking, which helps to maintain the coating integrity. Maintaining the coating integrity reduces or eliminates leakage of the center portion. Rewetting syrups may include water, liquid oil, carbohydrate based rewetting syrups, or a combination thereof. In one embodiment, the carbohydrate based rewetting syrups includes between about 10% and about 50% by weight of an aqueous solution of a soluble carbohydrate, such as, but not limited to, sucrose or fructose. Selection of the rewetting syrup is dependent upon at least one of a composition of the syrup layer, a predetermined product expansion, and a predetermined coating appearance (i.e. matte, shiny).

After the coated comestibles have been formed and optionally rewet, they are cooked to crisp and expand the shell and form the final crème filled snack. Suitable cooking methods include, but are not limited to, baking, frying, microwaving, or crisping in a snack crisper. The primary purpose of cooking is to drive off moisture to cause the shell to crisp, which is readily accomplished when cooked at high temperatures for short times. For example, in one embodiment, the coated comestible is baked at a temperature in the range of 204.4° C. (400° F.) to 232.2° C. (450° F.) for a time between one and six minutes. In another embodiment, the coated comestible is baked at a temperature in the range between about 218.3° C. (425° F.) and about 221.1° C. (430° F.) for about 4 to 5 minutes. During cooking, the shell also expands. It will be appreciated that the degree of expansion varies, being affected by the type of carbohydrates selected for use in the carbohydrate based syrup, as well as the choice of starches and flours used in the powdery starch blend.

Exemplary embodiments are further described and illustrated with respect to the following examples which are presented by way of explanation, not of limitation.

### EXAMPLES

### Example 1

Bake-stable dark chocolate was produced by infusing 2.0% by weight glycerol into a tempered dark chocolate to form a fat-based crème. The tempered dark chocolate was then immediately drop rolled to form a 1.6 gram bake-stable dark chocolate crème center portion.

The dark chocolate center portion was then coated with a carbohydrate based syrup and a powdery starch blend. The composition of the syrup was 35% sugar; 1% salt; 10.5% glucose syrup; 0.5% flavorant; and 53% water (all percentages are by weight). The ingredients were mixed together and cooked to 100° C. (212° F.) prior to coating. The composition of the powdery starch blend was 50% pre-gelatinized waxy corn starch; 25% all purpose wheat flour; and 25% rice flour (all percentages by weight).

To coat the center, the dark chocolate center was first tumbled in a rotating pan. Thereafter, the syrup was pan coated on the center to a coating of 1.0% by weight of the center. At that point, the powdery starch blend was introduced and coated until 1.2% by weight of the center was applied. The coated comestibles were tumbled at room temperature for about two minutes.

The syrup and powdery starch coating steps followed by two minutes of tumbling were repeated twenty-two times.

The coated comestibles were then removed from the pan, spread out, and sprayed to uniformly rewet the surface with a finishing syrup having 50% fructose and 50% water (by weight) that had been cooked to 100° C. (212° F.). After spraying, the coated comestibles were baked at 218.3° C. (425° F.) for four and a half minutes to form a crunchy bite-sized snack filled with dark chocolate that had a crème filling that was about 70% by weight of the coated comestible.

### Example 2

Bake-stable milk chocolate was produced by infusing 0.5% by weight glycerol into a tempered milk chocolate to form a fat-based crème. The tempered milk chocolate was then immediately drop rolled to form a 1.3 gram bake-stable milk chocolate center portion.

The milk chocolate crème center portion was then coated with alternating layers of a syrup and powdery starch blend similar to that described in Example 1. In this example, the syrup had a composition of 37% polydextrose; 1.9% salt; 10.5% glucose syrup; and 50.6% water (all by weight) that was cooked to 100° C. (212° F.), cooled to 22.2° C. (72° F.), and then pan coated on the center to a coating of 1.2% by weight of the original center. The powdery starch was added at 1.4% by weight of the center and had a composition that was 50% pre-gelatinized waxy corn starch; 33% potato flour; 10% rice flour; 5% Canola oil; and 2% salt (all by weight).

The coated centers were then tumbled at room temperature for about two minutes and the coating and tumbling steps were repeated twenty times to yield a coated comestible with a coating of about 30% of the total coated comestible weight.

The coated comestibles were then removed from the pan, spread out, and sprayed with Canola oil to uniformly oil the surface. After spraying, the coated comestibles were baked at 218.3° C. (425° F.) for 5 minutes to form a sweet and salty bite-sized crunchy potato snack filled with milk chocolate.

Example 3.

A chocolate crème have a composition of 27% palm oil; 42% sugar; 9% cocoa powder; 3% chocolate liquor; 3% milk fat; 10% milk powder; 5% whey; and 1% emulsifier (all by weight) was melted, cooled to 26.7° C. (80° F.), and then drop rolled to form a 1.75 gram chocolate crème center portion.

The chocolate crème center portion was then coated with alternating layers of a carbohydrate syrup and powdery starch blend similar to that described in Example 1. In this example, the syrup had a composition of 60% sucrose and 40% water (by weight) that was cooked to 65.6° C. (150° F.), cooled to 22.2° C. (72° F.), and then pan coated on the chocolate crème center to a coating of 1.0% by weight of the original center. The powdery starch blend was added at 1.2% by weight of the center and had a composition that was 50% pre-gelatinized waxy corn starch; 25% all purpose wheat flour; and 25% rice flour (all by weight).

The coated centers were then tumbled at room temperature for about two minutes and the coating and tumbling steps were repeated twenty-two times to yield a coated comestible with a coating of about 35% of the total coated comestible weight.

The coated comestibles were then removed from the pan, spread out, and sprayed with water to uniformly wet the surface. After spraying, the coated comestibles were baked at 218.3° C. (425° F.) for 5 minutes to form a sweet snack with the chocolate crème center in a crunchy baked outer coating.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method of making a crème filled snack, comprising:
providing a fat-based crème as a center portion;
applying a carbohydrate based syrup over a surface of the center portion, the carbohydrate based syrup comprising between about 30% and about 70% by weight solids; thereafter
applying a powdery starch blend over the syrup, the powdery starch blend comprising flour and a starch, the starch present as at least 40% by weight of the powdery blend;
repeating the steps of applying the carbohydrate based syrup and powdery starch blend to form a shell coating around the center portion, the shell coating and the center portion forming a coated comestible; and
cooking the coated comestible to form the shell coating having a crisp outer shell.

2. The method of claim 1, wherein providing the fat-based crème comprises infusing between about 0.5% and about 2% by weight of a viscosity modifier into the fat-based crème.

3. The method of claim 2, wherein the viscosity modifier is a polyol.

4. The method of claim 3, wherein the viscosity modifier comprises glycerol.

5. The method of claim 1, wherein the solids in the provided syrup are selected from the group consisting of soluble carbohydrates, soluble fibers, and combinations thereof.

6. The method of claim 5, wherein the soluble carbohydrates are selected from the group consisting of sucrose, glucose, maltose, lactose, fructose, corn syrup, corn syrup solids, rice syrup, agave syrup, and combinations thereof.

7. The method of claim 5, wherein the soluble fibers are selected from the group consisting of polydextrose, inulin, and combinations thereof.

8. The method of claim 1, wherein the starch in the applied powdery starch blend comprises waxy pre-gelatinized corn starch.

9. The method of claim 1, further comprising repeating the steps of applying the syrup and powdery starch blend until the shell coating comprises in the range of 25% to 45% by weight of the coated comestible.

10. The method of claim 1, further comprising repeating the steps of applying the syrup and powdery starch blend until the shell coating comprises in the range of 30% to 35% by weight of the coated comestible.

11. The method of claim 1, further comprising cooking the coated comestible at a temperature in the range of about 204° C. to about 232.2° C. for a time in the range of one to six minutes.

12. The method of claim 1, wherein the steps of applying the syrup and the powdery starch blend each comprise panning.

13. The method of claim 1 further comprising the step of spraying the coated comestible with a finishing liquid to uniformly rewet an exterior portion of the shell coating after the repeating steps and prior to the step of cooking;

14. A method of making a crème filled snack, comprising:
providing a fat-based crème center comprising tempered chocolate and 0.5% to 2% by weight glycerol;
tumbling the center in a pan coater;
applying an aqueous carbohydrate based syrup comprising between about 30% and about 70% by weight sucrose over a surface of the center in the pan coater;
applying a powdery starch blend over the syrup in the pan coater, the powdery starch blend comprising a flour and at least 40% by weight pre-gelatinized waxy corn starch; and
repeating the steps of applying the syrup and powdery starch blend to build up a shell coating in the range of about 25% to about 45% by weight of a coated comestible thereby formed; and
cooking the coated comestible to form the shell coating into a crispy shell.

15. The method of claim 11, further comprising repeating the steps of applying the syrup and powdery starch blend until the shell coating comprises between about 30% and about 35% by weight of the coated comestible.

16. The method of claim 11, wherein the step of cooking comprising baking at a temperature in the range of about 204° C. to about 232.2° C. for a time in the range of about one to about six minutes.

17. A crème filled snack, comprising:
a fat-based crème center comprising up to about 2% by weight of a polyol viscosity modifier; and
a shell coating around the fat-based crème center, the shell coating comprising at least three pairs of alternating carbohydrate based syrup and powdery starch blend layers, the carbohydrate based syrup layer comprising between about 30% and about 70% by weight solids and the powdery blend layer containing flour and at least 25% by weight of a pre-gelatinized waxy corn starch;
wherein the shell coating is configured to crisp during cooking to form a crunchy shell and wherein the fat-based crème center comprises at least 55% of the snack by weight.

18. The crème filled snack of claim 17, wherein the fat-based crème center comprises a fat-based crème selected from the group consisting of chocolate crème, tempered chocolate crème, vanilla crème, nut butter crème, and fruit flavored crème.

19. The crème filled snack of claim 17, wherein the solids comprise at least one ingredient selected from the group consisting of soluble carbohydrates, and soluble fibers.

20. The crème filled snack of claim 19, wherein the soluble carbohydrates comprise the group consisting of sucrose, glucose, maltose, lactose, fructose, corn syrup, corn syrup solids, rice syrup, and agave syrup.

21. The crème filled snack of claim 19, wherein the soluble fibers comprise the group consisting of polydextrose and inulin.

22. The crème filled snack of claim 17, wherein the powdery starch blend comprises 25% to 60% by weight pre-gelatinized waxy corn starch and at least one flour selected from the group consisting of wheat flour, rice flour, potato flour, almond flour, cocoa powder, and combinations thereof.

23. The crème filled snack of claim 17, wherein the fat-based crème center comprises at least 70% of the crème filled snack by weight.
